(19) United States
(12) Patent Application Publication
(10) Pub. No.: US 2023/0393907 A1
(43) Pub. Date: Dec. 7, 2023

(54) ARITHMETIC PROCESSING APPARATUS AND ARITHMETIC PROCESSING METHOD

(71) Applicant: Fujitsu Limited, Kawasaki-shi (JP)

(72) Inventor: Takumi HONDA, Kawasaki (JP)

(73) Assignee: Fujitsu Limited, Kawasaki-shi (JP)

(21) Appl. No.: 18/175,012

(22) Filed: Feb. 27, 2023

(30) Foreign Application Priority Data
Jun. 7, 2022 (JP) 2022-092109

(51) Int. Cl. G06F 9/54; G06F 9/50

(52) U.S. Cl. CPC G06F 9/54; G06F 9/5038

(57) ABSTRACT

An arithmetic processing apparatus includes a plurality of processing circuits each configured to execute processing of a predetermined number of tasks, and each of the plurality of processing circuits: predicts, when there is an unprocessed task in another processing circuit at completion of processing of the predetermined number of tasks, a processing time of an unprocessed task for each processing circuit, and transfers at least one of tasks from a processing circuit that has a longest predicted processing time and has a predicted processing time equal to or larger than a threshold value to an own processing circuit to execute processing.

### CROSS-REFERENCE TO RELATED APPLICATION

This application is based upon and claims the benefit of priority of the prior Japanese Patent Application No. 2022-92109, filed on Jun. 7, 2022, the entire contents of which are incorporated herein by reference.

### FIELD

The embodiment discussed herein is related to an arithmetic processing apparatus and an arithmetic processing method.

### BACKGROUND

A task stealing method has been known in which, in a multiprocessor system, a part of tasks respectively allocated to a plurality of nodes is processed by another node to thereby improve performance while performing parallel processing of data. According to this type of method, for example, in order to suppress transfer of a task to a node including a processor close to a thermal limit, a task transfer destination is determined by a priority calculated based on a temperature, power consumption, and a frequency.

Japanese National Publication of International Patent Application No. 2018-531450, U.S. Pat. No. 7,565,651, Japanese Laid-open Patent Publication No. 2007-249786, and U.S. Patent Application Publication No. 2004/0019432 are disclosed as related art.

### SUMMARY

According to an aspect of the embodiments, an arithmetic processing apparatus includes a plurality of processing circuits each configured to execute processing of a predetermined number of tasks, and each of the plurality of processing circuits: predicts, when there is an unprocessed task in another processing circuit at completion of processing of the predetermined number of tasks, a processing time of an unprocessed task for each processing circuit, and transfers at least one of tasks from a processing circuit that has a longest predicted processing time and has a predicted processing time equal to or larger than a threshold value to an own processing circuit to execute processing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of an arithmetic processing apparatus according to an embodiment;

FIG. 2 is an explanatory diagram illustrating a configuration example of a local task list in FIG. 1;

FIG. 3 is a sequence diagram illustrating an example of operations of the arithmetic processing apparatus in FIG. 1;

FIG. 4 is an explanatory diagram illustrating an example of a state of a local task list when processing of a task H of a process P1 in FIG. 3 is ended;

FIG. 5 is a flowchart illustrating an example of an operation of a management node in FIG. 1;

FIG. 6 is a flowchart illustrating an example of operations of a process executed in each node in FIG. 1; and

FIG. 7 is a flowchart illustrating an example of processing in step S32 in FIG. 6.

### DESCRIPTION OF EMBODIMENTS

A method for screening a large number of compounds by executing a simulation of a molecular state in a parallel computer system has been known. According to this type of method, for example, a master node analyzes execution results of a plurality of simulations executed in parallel by worker nodes, and determines an execution order of the simulations.

For example, in a method such as virtual screening in which a plurality of nodes is operated in parallel to screen compounds, tasks may be evenly allocated to processes executed by each node without considering processing performance of the node. In this case, when the processing performances of the plurality of nodes are different from each other, a processing time of a node having a relatively low performance may become a bottleneck, increasing the overall processing time to complete the virtual screening.

According to one aspect, an object of the present disclosure is to avoid an increase in the entire processing time due to a bottleneck caused by the processing time of a processing unit having a low processing performance when a plurality of tasks is allocated to a plurality of processing units having different processing performance from each other to be processed.

Hereinafter, an embodiment will be described with reference to the accompanying drawings.

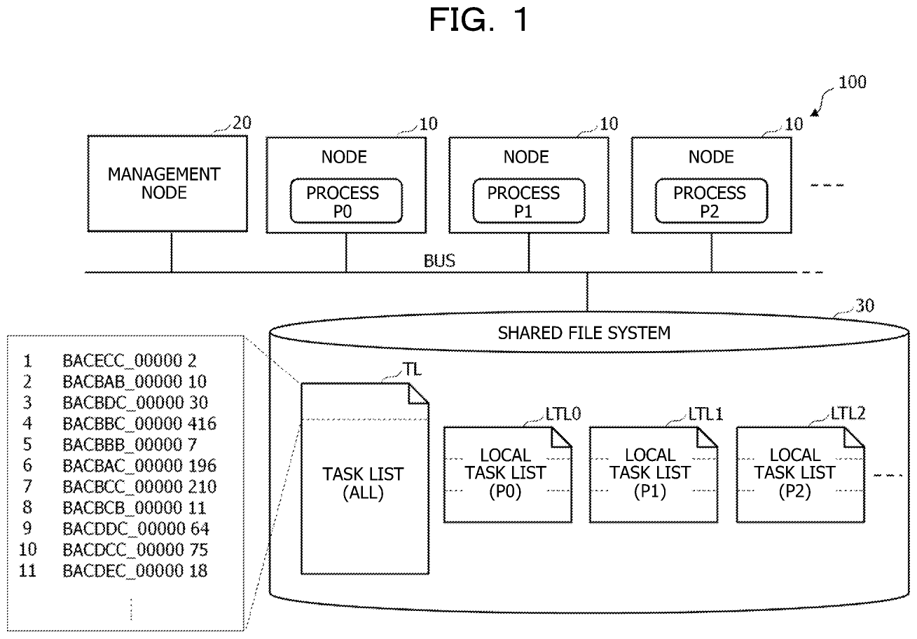

FIG. 1 illustrates an example of an arithmetic processing apparatus according to an embodiment. An arithmetic processing apparatus 100 illustrated in FIG. 1 includes a plurality of nodes 10, a management node 20, and a shared file system 30 that are coupled to each other via a bus BUS. The shared file systems 30 is an example of a holding unit accessible from the plurality of nodes 10.

Each node 10 is a calculator including a processor such as a central processing unit (CPU) that executes a process P (P0, P1, P2 or the like), and the plurality of nodes 10 functions as a cluster. For simplification, FIG. 1 illustrates an example in which each node 10 executes one process P for processing a task. However, for example, in a case where the processor of each node 10 includes a plurality of cores, each core may execute one process P. The node 10, the processor, or the core that executes one process P is an example of a processing unit that executes processing of a task.

An example in which three nodes 10 execute three processes P0 to P2, respectively, will be described below. However, the number of processes P executed by the arithmetic processing apparatus 100 is not limited to three, and may be two or four or more. For example, the process P, which processes tasks, is realized by a processor mounted on the node 10 executing a program.

For example, the arithmetic processing apparatus 100 executes a batch job by using a plurality of nodes 10, and performs virtual screening in which a candidate for a compound appropriate for a pharmaceutical product is extracted from a large number of compounds (for example, ligands) by screening. Although an example in which the arithmetic processing apparatus 100 performs virtual screening is described in this embodiment, the arithmetic processing apparatus 100 may perform a simulation other than virtual screening. The arithmetic processing apparatus 100 may be a server or a supercomputer used in the field of high performance computing (HPC).

Processing performances of the plurality of nodes 10 that respectively execute the processes P may differ from each other due to a failure of a part of a processor mounted on the node 10, a failure of a part of a built-in memory accessed by the processor, or the like. For example, in a case where the scale of the cluster realized by the arithmetic processing apparatus 100 is large, this may cause heterogeneous environment in which the processing performances of the processors mounted on the plurality of nodes 10 are different from each other. According to this embodiment, as will be described below, even when the processing performances of the plurality of nodes 10 that respectively execute the processes P are different from each other, it is possible to suppress an increase in the processing time of the entire virtual screening due to the influence of the node 10 having a low processing performance.

The management node 20 manages a plurality of nodes 10 that performs virtual screening and the shared file system 30. A task list TL indicating all of the tasks targeted for the virtual screening is allocated to the shared file system 30. For example, the task list TL is a text file in which all tasks for performing virtual screening are indicated. In the example illustrated in FIG. 1, each row of the task list TL indicates a ligand group, an alphabetic character string in each row indicates an identifier of a compound, and a number at the end of each row indicates the number of ligands.

A local task list LTL (for example, LTL0 to LTL2) that holds information on a task executed by each process P is allocated to the shared file system 30. The local task list LTL0 holds information on tasks to be executed by the process P0. The local task list LTL1 holds information on tasks to be executed by the process P1. The local task list LTL2 holds information on tasks to be executed by the process P2.

Task information that is information on tasks executed by each process P is moved from the task list TL to the local task list LTL of the own process P, and the moved task information is deleted from the task list TL. All the tasks described in the task list TL are sequentially processed by the processes P0 to P2. In a case where each node 10 includes a plurality of cores, each local task list LTL may be allocated in association with a plurality of processes P executed by a plurality of cores of the corresponding node 10.

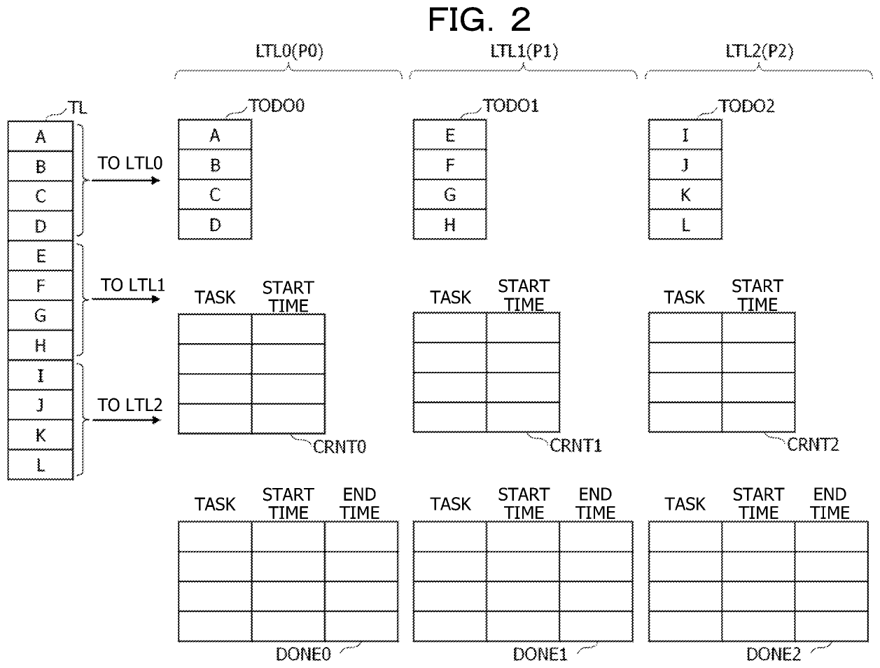

FIG. 2 is a diagram illustrating the configuration example of the local task lists LTL0 to LTL2 in FIG. 1. Each of the local task lists LTL0 to LTL2 includes an unprocessed list TODO (TODO0 to TODO2), a current processing list CRNT (CRNT0 to CRNT2), and a processed list DONE (DONE0 to DONE2). Hereinafter, the task information held in the task list TL and the local task list LTL0 to LTL2 is also simply referred to as a task. For example, it is referred to as “a task is held in the task list TL” or the like.

In the unprocessed list TODO, a task that has not been processed among the tasks to be processed in each process P is held. Before processing of a task is started, each process P acquires a predetermined number of tasks from the task list TL and stores the tasks in the unprocessed list TODO. Each process P deletes the task acquired from the task list TL from the task list TL.

In the current processing list CRNT, a task that is being processed in each process P and a processing start time of each task are held. Each process P acquires a task to start processing from the unprocessed list TODO, and stores the task in the current processing list CRNT together with the processing start time. Each process P deletes the task acquired from the unprocessed list TODO from the unprocessed list TODO.

In the processed list DONE, a task for which processing is completed in each process P, and a processing start time and a processing end time of each task are held. When processing of the task is completed, each process P acquires the task for which the processing is completed and the start time from the current processing list CRNT, and stores the start time in the processed list DONE together with the completed task. Each process P deletes the task and the start time acquired from the current processing list CRNT from the current processing list CRNT.

The processing time of each task may be stored in the processed list DONE instead of the start time and the end time. In this case, each process P calculates the processing time by subtracting the start time held in the current processing list CRNT from the processing end time of the task.

In the example illustrated in FIG. 2, all the tasks A, B, C, . . . , J, K, L (twelve) used for the virtual screening are stored in the task list TL in advance. For example, storing of tasks in the task list TL is performed by the management node 20. Before starting the virtual screening, each process P acquires four tasks that do not overlap each other from the task list TL and stores the four tasks in the unprocessed list TODO. For example, the plurality of tasks held in the task list TL is uniformly distributed to each process P.

As illustrated in FIG. 2, the process P0 stores the tasks A, B, C, and D in the unprocessed list TODO0. The process P1 stores the tasks E, F, G, and H in the unprocessed list TODO1. The process P2 stores the tasks I, J, K, and L in the unprocessed list TODO2. After a predetermined number of tasks are stored in the unprocessed lists TODO0 to TODO2 in advance, the virtual screening is started by the processes P0 to P2.

For simplification, FIG. 2 illustrates an example in which all the tasks stored in the task list TL are stored in the unprocessed lists TODO0 to TODO2 at one time. However, all the tasks (for example, 36) stored in the task list TL may be stored in the unprocessed lists TODO0 to TODO2 separately in several times. In this case, four tasks each are stored in the unprocessed list TODO, and the process P that has completed the processing of the four tasks stores the next four tasks in the unprocessed list TODO. Acquisition of tasks from the task list TL by each process P and processing of the acquired tasks are repeatedly performed until there is no task that has not been processed in the task list TL. Hereinafter, the task that has not been processed is also referred to as an unprocessed task.

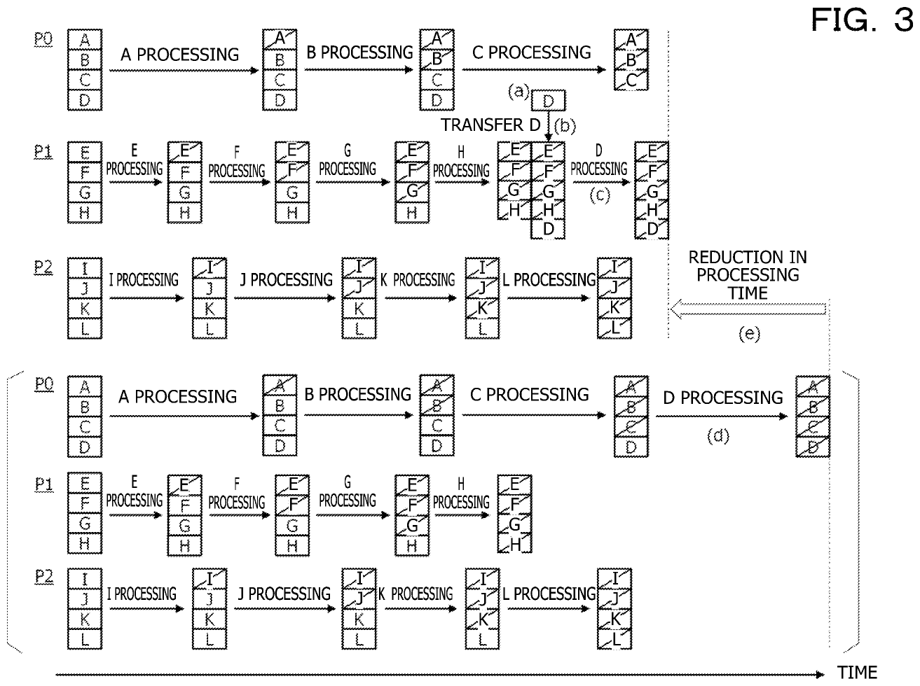

FIG. 3 illustrates an example of the operation of the arithmetic processing apparatus 100 illustrated in FIG. 1. FIG. 3 illustrates how the tasks are sequentially processed by each of the processes P0 to P2. A task indicated by a rectangle with diagonal line indicates that the task has been processed. A task indicated by a rectangle without a diagonal line indicates that the task is unprocessed or being processed. Arrows indicating the processing time of tasks are not uniform in length in each process P. For example, the processing time changes in accordance with the number of ligands in each row (ligand group) illustrated in the task list TL in FIG. 1.

According to this embodiment, for example, the processing performance of the node 10 that executes the process P0 is lower than the processing performance of the nodes 10 that execute the processes P1 and P2. The processing performance of the node 10 that executes the process P1 is higher than the processing performances of the nodes 10 that execute the processes P0 and P2. For example, the order of the processing speeds of the tasks in the processes P0 to P2 is as follows: P1, P2, P0 in descending order of speed. For this reason, for example, when the processing of the fourth task H by the process P1 is ended, the task D in the process P0 has not been processed ((a) in FIG. 3).

After the processing of the fourth task H is ended, the process P1 determines whether or not there is an unprocessed task in the other processes P0 and P2, and detects that the task D in the process P0 is unprocessed. The process P1 transfers the task D from the unprocessed list TODO0 to the unprocessed list TODO1, and deletes the transferred task D from the unprocessed list TODO0 of the process P0 ((b) in FIG. 3). The process P1 starts the processing of the task D ((c) in FIG. 3).

In the actual virtual screening, since a large number of tasks are processed, the large number of tasks are registered in the task list TL. After the processing of the fourth task H is ended, the process P1 determines whether or not there is an unprocessed task in the task list TL. After the processing of the fourth task H is ended, in a case where there is no unprocessed task in the task list TL, the process P1 determines whether or not there is an unprocessed task in the other processes P0 and P2. After the processing of the fourth task H is ended, in a case where there is an unprocessed task in the task list TL, the process P1 acquires the unprocessed task from the task list TL without determining whether or not there is an unprocessed task in the other processes P0 and P2, and performs the processing of the acquired task.

The square bracket in FIG. 3 indicates an example of an operation in a case where an unprocessed task is not transferred between the processes P. In a case where an unprocessed task is not transferred between the processes P, the task D is not transferred from the process P0 to the process P1 and is processed by the process P0 ((d) in FIG. 3). Accordingly, the end of processing of the virtual screening is delayed depending on the processing performance of the node that executes the process P0. For example, by transferring the unprocessed task between the processes P, it is possible to shorten the processing time for virtual screening as compared with a case where the unprocessed task is not transferred between the processes P ((e) in FIG. 3). As a result, it is possible to suppress a bottleneck in the processing time of the node 10 having low processing performance, and it is possible to avoid longer overall processing time for virtual screening or the like.

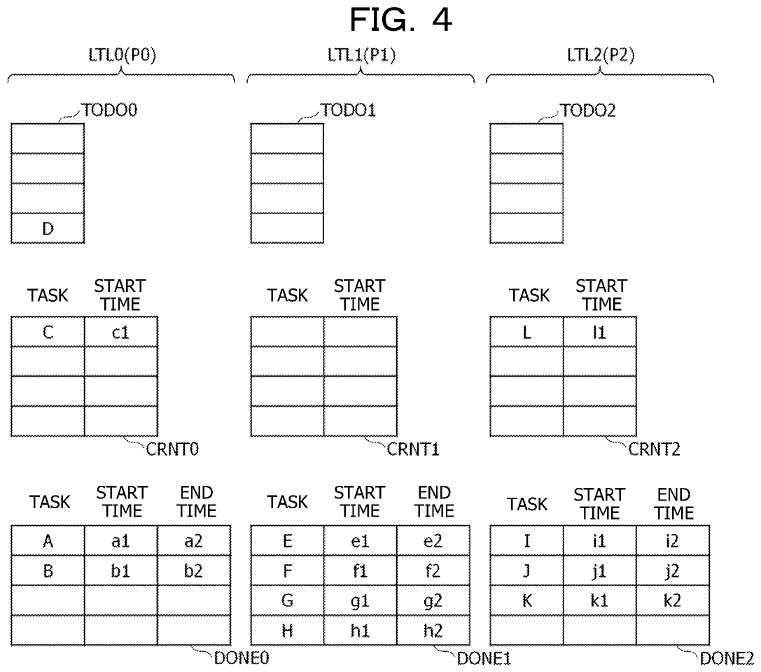

FIG. 4 illustrates an example of states of the local task lists LTL0 to LTL2 when the processing of the task H on the process P1 is ended in FIG. 3. In the local task list LTL0, the task D is held in the unprocessed list TODO0, and the task C and a start time ci of the task C are held in the current processing list CRNT0. The task A, a start time a1 and an end time a2 of the task A, the task B, a start time b1 and an end time b2 of the task B are held in the processed list DONE0.

In the local task list LTL1, the task E, a start time e1 and an end time e2 of the task E, the task F, a start time f1 and an end time f2 of the task F are held in the processed list DONE1. The task G, a start time g1 and an end time g2 of the task G, and the task H, a start time h1 and an end time h2 of the task H are held in the processed list DONE1.

In the local task list LTL2, the task L and a start time l1 of the task L are held in the current processing list CRNT2. The task I, a start time i1 and an end time i2 of the task I, the task J, a start time j1 and an end time j2 of the task J, and the task K, a start time k1 and an end time k2 of the task K are held in the processed list DONE2.

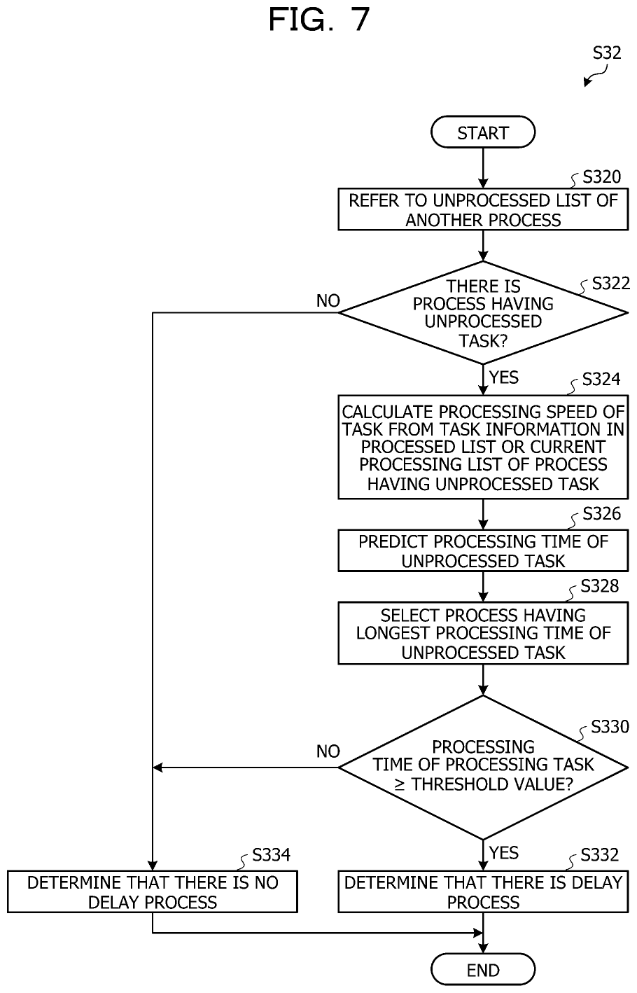

In a case where the processing of the task H has been ended, the process P1 transfers the task D from the unprocessed list TODO0 holding the unprocessed task D. For example, in a case where there is a plurality of unprocessed lists TODO holding an unprocessed task, the process P1 calculates processing times of the tasks respectively held in the plurality of unprocessed lists TODO. The process P1 selects the process P having the longest calculated processing time. A method for calculating the processing time of the tasks held in the unprocessed list TODO will be described with reference to FIG. 7.

In a case where the processing time of the task held in the unprocessed list TODO of the selected process P is equal to or larger than a preset threshold value, the process P1 transfers at least one of the tasks held in the unprocessed list TODO to the unprocessed list TODO1 of the own process P1. For example, in a case where the number n of unprocessed tasks of the selected process P is equal to or less than three, the process P1 transfers one unprocessed task to the unprocessed list TODO0. In a case where the number n of unprocessed tasks of the selected process P is equal to or more than four, the process P1 may transfer “n/2” unprocessed tasks to the unprocessed list TODO0.

In a case where the number of unprocessed tasks is large, the entire time taken for the transfer processing may be shortened by transferring a plurality of unprocessed tasks to the unprocessed list TODO as compared to a case where the unprocessed tasks are transferred one by one, and the processing time for virtual screening may be shortened. The threshold value may be set by a user who causes the arithmetic processing apparatus 100 to execute the virtual screening. The threshold value may be set in accordance with processing performance of a processor mounted on the node 10.

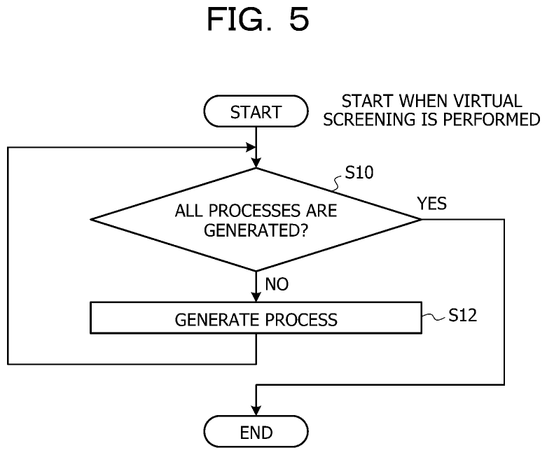

FIG. 5 is a flowchart illustrating an example of the operation of the management node 20 in FIG. 1. The management node 20 starts a flow illustrated in FIG. 5 when virtual screening is performed. For example, when the management node 20 receives an instruction to generate a predetermined number of processes P from a user or the like, the management node 20 starts the flow illustrated in FIG. 5.

First, in step S10, the management node 20 determines whether or not all processes P that perform virtual screening have been generated. When all the processes P are generated, the management node 20 ends the processing illustrated in FIG. 5, and when there is a process P that is not generated, the management node 20 causes the processing to proceed to step S12. For example, in step S10, the management node 20 generates one process P, and returns the processing to step S10.

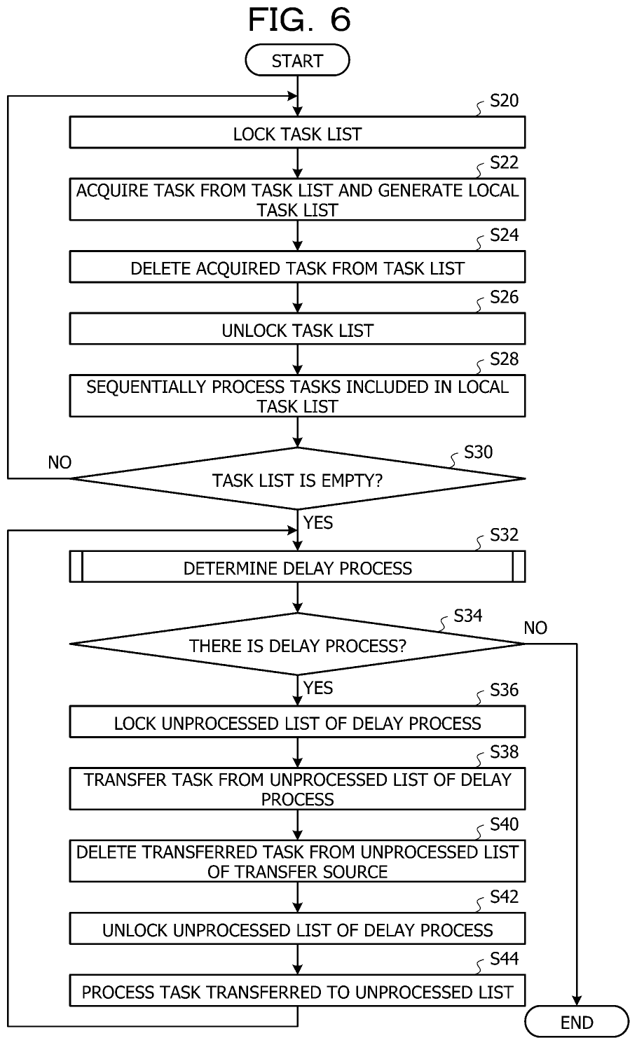

FIG. 6 is a flowchart illustrating an example of an operation of the process P executed in each node 10 in FIG. 1. Each process P starts the processing illustrated in FIG. 6 based on reception of an instruction to perform virtual screening from the management node 20.

First, in step S20, the process P locks the task list TL in order to inhibit the task list TL from being accessed by another process P. Next, in step S22, the process P generates the local task list LTL by acquiring a predetermined number of tasks held in the task list TL. For example, the process P stores the acquired task in the unprocessed list TODO of the local task list LTL.

Next, in step S24, the process P deletes the task acquired in step S22 from the task list TL. Next, in step S26, the process P unlocks the task list TL. Next, in step S28, the process P sequentially executes the processing of the tasks included in the unprocessed list TODO of the local task list LTL generated in step S22.

Next, in step S30, the process P that has completed the processing of all the tasks held in the unprocessed list TODO determines whether or not the task list TL is empty. In a case where the task list TL is empty (in a case where there is no task to be processed), the process P causes the processing to proceed to step S32. In a case where a task is held in the task list TL, the process P returns to step S20 and performs the processing in step S20 to step S28.

In step S32, the process P performs the delay process determination to check the progress status of the task processing of another process P, and determines whether or not there is a process P (delay process) that demands task transfer. An example of the delay process determination is illustrated in FIG. 7. Next, in step S34, based on the determination result in step S32, the process P causes the processing to proceed to step 36 in a case where there is a delay process, and ends the processing illustrated in FIG. 6 in a case where there is no delay process.

In step S36, the process P locks the unprocessed list TODO of the delay process. Next, in step S38, the process P transfers at least one of the tasks held in the unprocessed list TODO of the delay process to the unprocessed list TODO of the own process P. Next, in step S40, the process P deletes the transferred task from the unprocessed list TODO of the transfer source.

Next, in step S42, the process P unlocks the unprocessed list TODO of the delay process. Next, in step S44, the process P processes the task that is transferred to the unprocessed list TODO of the own process P in step S38, and returns to step S32.

FIG. 7 illustrates an example of processing in step S32 in FIG. 6. First, in step S320, the process P refers to the unprocessed list TODO of the local task list LTL of another process P. Next, in step S322, the process P determines whether or not there is a process P having an unprocessed task on which processing is not performed, based on the referred unprocessed list TO DO. In a case where there is a process P having an unprocessed task, the process P causes the processing to proceed to step S324, and in a case where all the processes P do not have an unprocessed task, the process P causes the processing to proceed to step S334.

In step S324, the process P calculates a processing speed, which is a processing time for each task that has been processed or is being processed, based on task information held in the processed list DONE or the current processing list CRNT of the process P having an unprocessed task. A processing speed indicates an average of processing times for each task. In a case where there is a plurality of processes P each having an unprocessed task, step S324 is executed for each process P.

For example, the process P calculates the processing time of each task by subtracting the start time from the end time for each processed task held in the processed list DONE of the process P having an unprocessed task. The process P calculates a processing speed of a task by dividing the calculated sum of processing times by the number of processed tasks. In a case where there is one processed task, the process P calculates a processing speed by dividing the calculated processing time by “1”.

In a case where there is no processed task, the process P calculates an elapsed time from the start time held in the current processing list CRNT of the process P having an unprocessed task to the current time, and calculates a processing speed by dividing the calculated elapsed time by “1”. Accordingly, in the case where there is no processed task, it is possible to calculate the processing speed of the task by using the task information held in the current processing list CRNT.

Next, in step S326, the process P predicts the processing time of the unprocessed task of the process P having the unprocessed task based on the task processing speed calculated in step S324. In a case where there is a plurality of processes P each having an unprocessed task, step S326 is executed for each process P. For example, the process P calculates a predicted value of the processing time of the task by multiplying the processing speed calculated in step S324 by the number of unprocessed tasks held in the unprocessed list TODO.

Next, in step S328, the process P selects the process P having the longest processing time of the unprocessed task. In a case where there is only one process P having an unprocessed task, the process P selects the process P for which the processing time is predicted in step S326.

Next, in step S330, the process P determines whether or not the predicted value of the processing time of the unprocessed task of the process P selected in step S328 is equal to or larger than a preset threshold value. The process P causes the processing to proceed to step S332 in a case where the predicted value of the processing time of the unprocessed task is equal to or larger than the threshold value, and causes the processing to proceed to step S334 in a case where the predicted value of the processing time of the unprocessed task is less than the threshold value. In step S332, the process P determines that there is a delay process, and ends the processing illustrated in FIG. 7. In step S334, the process P determines that there is no delay process, and ends the processing illustrated in FIG. 7.

As described above, in this embodiment, in a case where a plurality of tasks is allocated to a plurality of nodes 10 having different processing performances from each other to be processed, by transferring an unprocessed task between the processes P, it is possible to suppress a bottleneck in the processing time of the node 10 having low processing performance. As a result, it is possible to avoid an increase in the entire processing time for virtual screening or the like, as compared with a case where an unprocessed task is not transferred between the processes P.

The own process P that has completed the processing of the predetermined number of tasks may, by referring to the unprocessed list of the other process P, easily determine whether or not an unprocessed task is present. The own process P may calculate, by referring to the start time and the end time held in the processed list DONE of the process P having an unprocessed task, the processing speed of the task, and may predict the processing time of the unprocessed task based on the calculated processing speed. For example, the own process P may easily calculate the predicted value of the processing time of the unprocessed task by multiplying the calculated processing speed of the task by the number of unprocessed tasks held in the unprocessed list TODO.

The own process P that has completed the processing of the predetermined number of tasks may calculate the predicted value of the processing time of the unprocessed task based on the start time of the task held in the current processing list CRNT of the process P having an unprocessed task and the current time. Accordingly, even in a case where there is no task for which processing is completed in the process P having an unprocessed task, it is possible to easily predict the processing time of the unprocessed task.

When task information of all the tasks held in the task list TL has been acquired, each process P determines completion of processing of a predetermined number of tasks and determines whether or not to transfer a task from another process P. As described above, each process P may determine completion of the processing of the predetermined number of tasks by referring to the task list TL. By deleting task information each time the task information is acquired from the task list TL, each process P may easily determine completion of processing of the predetermined number of tasks.

Regarding the embodiment illustrated in FIG. 1 to FIG. 7, the following appendices are further disclosed.

Features and advantages of the embodiment are clarified from the above detailed description. The scope of claims is intended to cover the features and advantages of the embodiment as described above within a range not departing from the spirit and scope of right of the claims. Any person having ordinary skill in the art may easily conceive every improvement and alteration. Accordingly, the scope of inventive embodiment is not intended to be limited to that described above and may rely on appropriate modifications and equivalents included in the scope disclosed in the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing apparatus that includes a plurality of processing circuits each configured to execute processing of a predetermined number of tasks,
wherein each of the plurality of processing circuits:
predicts, when there is an unprocessed task in another processing circuit at completion of processing of the predetermined number of tasks, a processing time of an unprocessed task for each processing circuit, and
transfers at least one of tasks from a processing circuit that has a longest predicted processing time and has a predicted processing time equal to or larger than a threshold value to an own processing circuit to execute processing.

2. The arithmetic processing apparatus according to claim 1, comprising
a memory to which an unprocessed list in which unprocessed task information that indicates an unprocessed task is held and a processed list in which processing time information that indicates a processing time of a processed task is held are allocated for each of the plurality of processing circuits, and to which the plurality of processing circuits is accessible,
wherein the processing circuit that has completed processing of the predetermined number of tasks determines presence or absence of an unprocessed task by referring to the unprocessed list corresponding to the other processing circuit, and predicts a processing time of an unprocessed task based on processing time information held in the processed list corresponding to the other processing circuit.

3. The arithmetic processing apparatus according to claim 2,
wherein the processing circuit that has completed processing of the predetermined number of tasks calculates a processing speed that is a processing time for each task based on processing time information held in a processed list corresponding to the other processing circuit, and calculates a predicted value of a processing time for an unprocessed task by multiplying a calculated processing speed by the number of unprocessed tasks indicated in the unprocessed list.

4. The arithmetic processing apparatus according to claim 2,
wherein a current processing list in which a start time of a task in processing is held is further allocated to the memory for each of the plurality of processing circuits, and
the processing circuit that has completed processing of the predetermined number of tasks sets, when the processing time information is not held in the processed list corresponding to the other processing circuit, an elapsed time from a start time held in the current processing list corresponding to the other processing circuit to a current time as a predicted value of a processing time of an unprocessed task.

5. The arithmetic processing apparatus according to claim 2,
wherein a task list in which task information that indicates each of all tasks to be processed in the plurality of processing circuits is held is further allocated to the memory, and
each of the plurality of processing circuits repeats an operation of acquiring a plurality of pieces of task information from the task list and sequentially processing a plurality of tasks corresponding to the acquired plurality of pieces of task information, and determines that processing of the predetermined number of tasks is completed when all pieces of task information are acquired from the task list at completion of processing of the plurality of tasks.

6. The arithmetic processing apparatus according to claim 5,
wherein each of the plurality of processing circuits deletes, when a plurality of pieces of task information is acquired from the task list, an acquired plurality of pieces of task information from the task list, and determines that processing of the predetermined number of tasks is completed when there is no task information held in the task list.

7. The arithmetic processing apparatus according to claim 1,
wherein the task is processed by a process executed by the plurality of processing circuits.

8. The arithmetic processing apparatus according to claim 1,
wherein virtual screening is performed by a task processed by each of the plurality of processing circuits.

9. An arithmetic processing method comprising:
predicting, by each of a plurality of processing circuits each configured to execute processing of a predetermined number of tasks and included in an arithmetic processing apparatus, when there is an unprocessed task in another processing circuit at completion of processing of the predetermined number of tasks, a processing time of an unprocessed task for each processing circuit, and
transferring at least one of tasks from a processing circuit that has a longest predicted processing time and has a predicted processing time equal to or larger than a threshold value to an own processing circuit to execute processing.
